(19) United States
(12) Patent Application Publication
(10) Pub. No.: US 2014/0255004 A1
(43) Pub. Date: Sep. 11, 2014

(54) AUTOMATICALLY DETERMINING AND TAGGING INTENT OF SKIPPED STREAMING AND MEDIA CONTENT FOR COLLABORATIVE REUSE

(71) Applicant: INTERNATIONAL BUSINESS MACHINES CORPORATION, Armonk, NY (US)

(72) Inventors: Corville Orain Allen, Morrisville, NC (US); James E. Carey, Rochester, MN (US); Jason J. Illg, Eau Claire, WI (US); John Stephen Mysak, Rochester, MN (US)

(73) Assignee: INTERNATIONAL BUSINESS MACHINES CORPORATION, Armonk, NY (US)

(21) Appl. No.: 13/788,549

(22) Filed: Mar. 7, 2013

(51) Int. Cl. H04N 9/79

(52) U.S. Cl. CPC H04N 9/79
USPC 386/241

(57) ABSTRACT

A method, system, and computer program product for bypassing as portion of content of a media. A history of skipped sections for a media is accumulated. Each portion of skipped content is detected during a display of the media. A reason is automatically determined for each portion of media content that is skipped based on a set of predefined criteria and resulting in a measured value for each portion of skipped content. Each portion of skipped content is tagged with the associated measured value. Information associated with the tagged portions of skipped content is shared across a social network for collaborative reuse. A determination is also made whether or not the previously skipped portion or media content exceeds a predetermined user display threshold. Responsive to a user-configurable policy for bypassing content, the content of the media is automatically displayed on a user device and content exceeding the predetermined display threshold is skipped.

### BACKGROUND

Embodiments of the invention generally relate to tagging and editing of audiovisual content and, more specifically to determining and tagging the intent of skipped streaming and media content for collaborative reuse across a social network to prevent inappropriate content from being displayed to a select audience.

Parents are frequently confronted with the dilemma of deciding which portions of an audiovisual program are suitable for their young children. In general, in order to enable parents to control the content of broadcast, cable, and satellite audiovisual programming, parental control products such as the V-chip have been developed to block transmission of programs individually selected or matching content criteria codes selected by the parent.

Many programs of interest to children are generally acceptable to parents, but may contain scenes that are inappropriate for viewing by children. In such cases, parental control products give parents the option of allowing or blocking the generally acceptable programs that may contain specific objectionable scenes or content. Alternatively, parents can preview an entire program to identify objectionable scenes and then watch it again with their children in order to fast forward through the objectionable scenes. This has the obvious disadvantage of the parent having to watch the program twice.

The embodiments provide a method for collaborating across social and other networks to facilitate enhanced viewing for protection of younger viewers from objectionable media content.

In an exemplary embodiment, a method is provided for bypassing a portion of content of a media. The method includes accumulating a history of skipped content for the media; detecting each portion of skipped content during a display of the media; automatically determining a reason for each portion of media content that is skipped based on a set of predefined criteria and resulting in a measured value for each portion of skipped content; tagging each portion of skipped content with the associated measured value; and sharing information associated with the tagged portions of skipped content across a social network for collaborative reuse.

In a further aspect, a previously skipped portion of media content is detected rising the shared information associated with the tagged portions of skipped content. A user's profile and display preferences for media is determined. A determination is also made whether or not the previously skipped portion of media content exceeds a predetermined user display threshold. Responsive to a user-configurable policy for bypassing content, the content of the media is automatically displayed on a user device and content exceeding the predetermined display threshold is skipped.

### BRIEF DESCRIPTION OF THE SEVERAL VIEWS OF THE DRAWINGS

These and other advantages and aspects of the of the embodiments of the disclosure will become apparent and more readily appreciated from the following detailed description of the embodiments taken in conjunction with the accompanying drawings, as follows.

FIG. 1 illustrates a system diagram for determining and tagging the intent of skipped streaming and media content for collaborative reuse across a social network in accordance with an exemplary embodiment.

FIG. 2 illustrates processing logic for identification and tagging of offensive content, and sharing of metadata in accordance with an exemplary embodiment.

FIG. 3 illustrates processing logic for viewing an audiovisual program stream with proactively skipped content in accordance with an exemplary embodiment.

### DESCRIPTION

The following description is provided as an enabling teaching of embodiments of the invention including the best, currently known embodiment. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the invention and not in limitation thereof, since the scope of the invention is defined by the claims.

Parents want to be able to watch certain audiovisual programs with their children, but with the ability to automatically skip and block content deemed to be inappropriate for their children. In certain cultures, vulgarity, violent content, and sexual content are perceived differently. For example, in the U.S. violent content is more likely to be tolerated by parents than sexual content. In European countries, the opposite is true. The disclosed embodiments allow scenes to be skipped based on the preferences of the user by either alerting the user to the objectionable content or automatically skipping the content when possible.

It is highly likely that there are many other people across the world that would have similar issues and would take similar actions. By enabling these skipped parts to be shared with other users, along with the intent of the skip, the other users could benefit from this process without having to be ever vigilant with the remote control to skip entire scenes.

The disclosed embodiments, facilitate enhanced viewing by users by enabling collaboration of these identified skipped parts across social networks to tag scenes and content that may be inappropriate, automatically capture users' behavior while watching certain programs, and predictively tag sections for future enhanced “censored” viewings.

Television commercials are another potential issue, particularly with regards to certain types of programming such as sports programs. The disclosed embodiments could be used to skip previously tagged commercials having objectionable content, to block the viewing of these commercials if the programming does not allow the commercials to be skipped.

Skipped content metadata can be shared across social networks or via television services such as Netflix to allow consumers to proactively skip content based on the shared metadata and individual preferences.

Embodiments described herein collaboratively and intelligently tag scenes and frames within an audiovisual program based on user preferences and real-time actions in a social environment to build metatags that automatically skip objectionable content during audiovisual programs. The metatags associated with scenes and frames within an audiovisual program to censor certain parts of a scene are utilized to skip ahead or mute content.

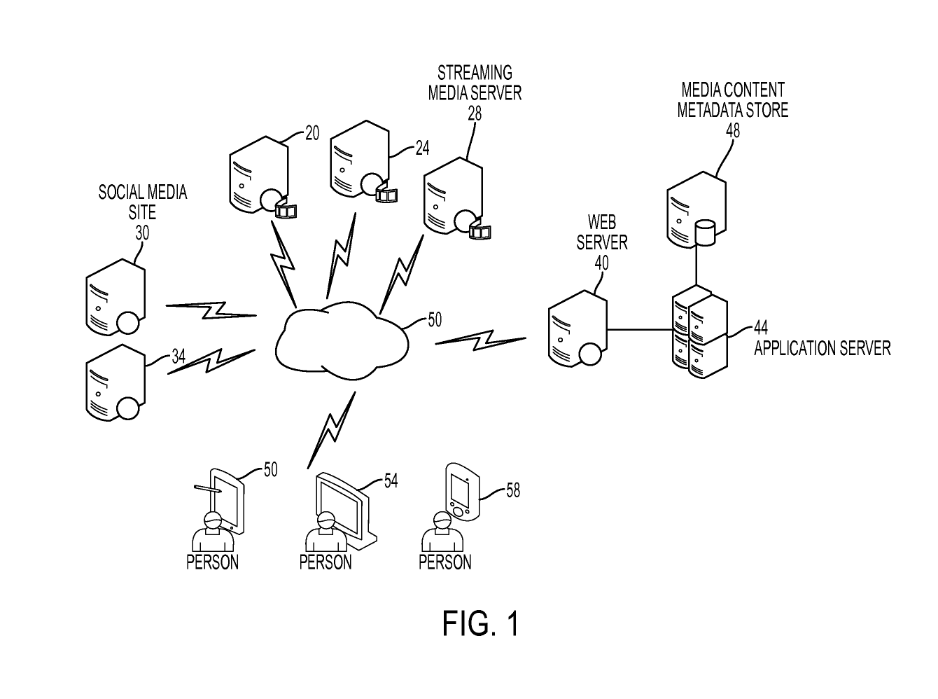

FIG. 1 illustrates an exemplary system diagram for determining and tagging the intent of skipped streaming and content for collaborative reuse across a social network (e.g., 30). In an exemplary embodiment, the live streaming device, or media-streaming devices (e.g., 24) with Internet access (e.g., 50), can detect user actions (e.g., 54), i.e., what content was skipped and then save it. After a section is skipped, a score can be computed in order to disambiguate the intent of skipping the section. The system 10 must be able to discern the intent, some of which could include: (1) boring scene, (2) previously watched scene, and (3) scene having inappropriate content for certain ages. In exemplary embedments, a score can be determined regarding the likelihood that the content is not appropriate for certain ages and the content is tagged so that other users can skip the same content.

To determine if the reason for skipping content is related to the content not being appropriate for certain ages, a score can be computed based on a number of categories including, but not limited to, social network membership and profile, timing of audiovisual streaming, analysis of skipped image frames, analysis of subtitles, and analysis of sound. For example, as part of a social network registration process, a user profile can be created on the social network 30, 34 such that it knows that the user has two children and their specific ages. The system 10 knows when the show was watched (a show watched after 11:00 PM probably was not watched by children). This information can be cross-referenced against the social network 30, 34 if the children's bed time was published to be more deterministic. The analysis of skipped streamed image frames could indicate the appearance of blood or sexual content in the skipped content. Analysis of subtitles could indicate that there was rude language in the skipped content. Analysis of sound could indicate weapons are being fired or a character is dying in the skipped content. In exemplary embodiments, a score can be computed based on at least these five categories and, if a certain threshold score is passed, a determination can be made that it was highly likely that the content was skipped due to inappropriate content for the given age group. In other embodiments, more or fewer than five categories could be used to determine a score for the skipped content.

In one embodiment of the invention, a method is provided to bypass a portion of audiovisual media content based on collaborative metatags. An accumulated history of skipped sections for a media can be given a weighted value based on specified criteria. Responsive to a user configurable policy for skipping a media section (e.g., fast forwarding, bypassing, muting), and a media section exceeding a predetermined threshold, the media content can be presented automatically with the skipped media section. In some embodiments, the media content could comprise a streaming media such as an audiovisual media, and the reason(s) for skipping the section could be derived from one of a user selection and a user social media (i.e., collaborative exchange). In some embodiments, the reason for skipping a media section can be selected from one or more of the following types of content: age appropriate content, boring content, violent content, language content, sexual content, and previously watched content. The history of skipped sections can be accumulated automatically utilizing user activity and the likelihood of matching criteria utilizing one or more items selected from the group: social network information (e.g., children of specific ages), timing (when the media was viewed), analysis of the skipped material (e.g., sex scene, blood, etc.), analysis of subtitles, and analysis of sound (e.g., gun fire).

The exemplary system diagram illustrated in FIG. 1 for determining and tagging the intent of skipped streaming and media content for collaborative reuse across a social network includes a number of hardware and software components that communicate over a broadband communications system, such as the Internet 50. The exemplary system 10 includes streaming media servers 20, 24, 28; social media sites 30, 34; web server 40, application server 44, and media content metadata store 48; and user client devices such as tablet 50, PC or laptop 54, and personal digital assistant/smartphone 58. Streaming media servers/services can include sites such as Netflix, Hulu Plus, Vudu, YouTube, and Amazon Video on Demand among other services that stream video on demand to user client devices. These streaming media sites can be streamed by various devices to an end user client including laptops/personal computers, Apple TV, Roku, Google TV, Sony PlayStation 3, DVD/Blu-ray players, and Western Digital's WD TV Live Hub among current commercially available devices.

Software components included in the exemplary system 10 are web server 40, application server 44, and media content data store 48. These components form the service provider hosted environment. Web server 40 is the front end to application server 44 and exposes a web service interface for tagging of skipped content. Application server 44 is the backend component of the service provider hosted environment. It stores metadata associated with skipped/tagged content in media content metadata store 48.

Two other software components included in exemplary embodiments can be resident on either a server computer or a client device. User preferences data store is responsible for storing user preferences for streaming of audiovisual content. The location of this software component can be either on a client device and/or a server depending upon client device capabilities and user preferences—online or offline. In one embodiment, offline mode allows users to store preferences locally on the client device. The other software component that can be resident on either a server computer or a client device is the skipped content detection module. The function of the skipped content detection module is to detect skipped content on the client viewing device. The location of this software component can be either on a client device and/or a server depending upon client device capabilities and user preferences—online or offline, in one embodiment, offline mode allows users to tag content for later transmission to the application provider when possible.

Application server 44 includes additional software modules which when executed on a computer processor automatically determine and tag intent of skipped streaming and media content. These modules include a tagging service module, a scoring service module, and a metadata sharing module. The tagging service module is a web service that is invoked by the skipped content detection module. The scoring service module scores skipped content based on predefined categories, e.g., language, violence, social network data, etc. The metadata sharing module is a web service invoked by external clients (e.g., social media sites and client devices) to access metadata for the purpose of allowing users to proactively skip content based on user preferences and social media profile information.

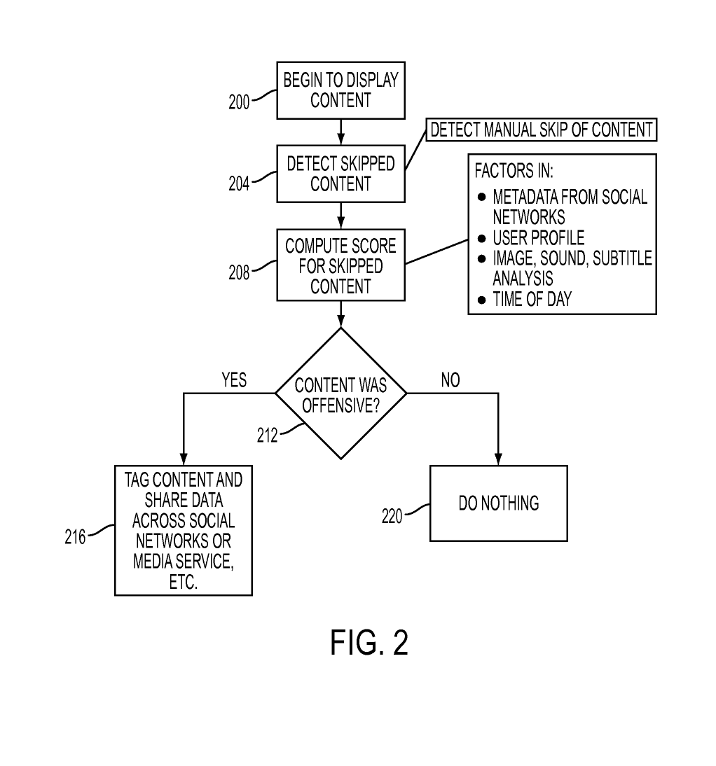

FIG. 2 illustrates exemplary processing logic for identification and tagging of offensive content, and sharing of metadata. The process commences as indicated in logic block 200 with the audiovisual content beginning its display on a display device. In logic block 204, the manual skipping of audiovisual content is detected. Next, a score is determined automatically for the skipped content as indicated in logic block 208. Factors that could be considered in some embodiments include metadata obtained from social networks; a registered user profile; analysis of image, sound, and subtitles; and time of day. A determination is made as to whether or not the skipped content was offensive based on the determined score as indicated in decision block 212. If the content was not determined to be offensive, no additional processing is performed as indicated in logic block 220. If the content was determined to be offensive in decision block 212, then the skipped content is tagged and shared across social networks and/or media services as indicated in logic block 216.

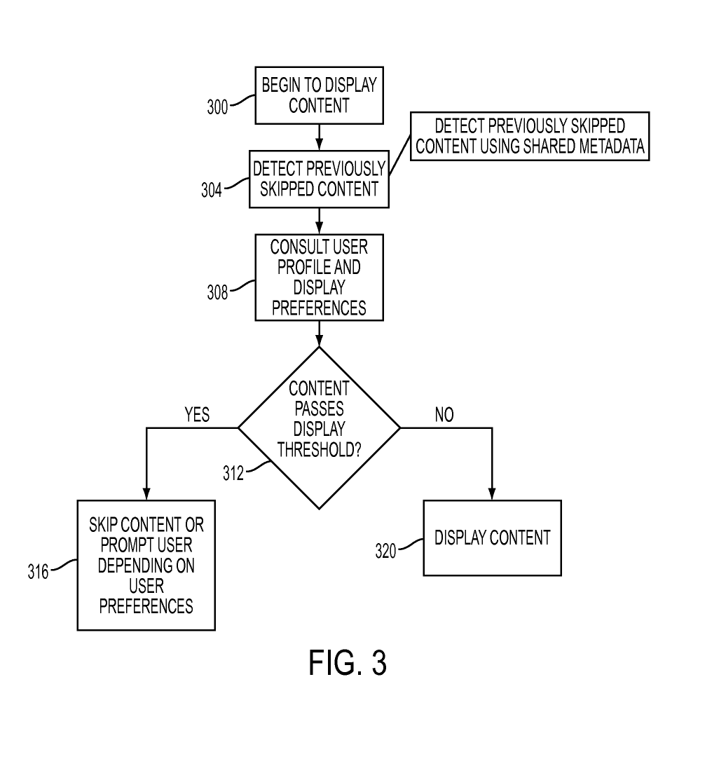

FIG. 3 illustrates exemplary processing logic for viewing an audiovisual program stream with proactively skipped content in accordance with an exemplary embodiment. The process commences as indicated in logic block 300 with the audiovisual content beginning its display on a display device. Previously skipped content is detected using shared metadata as indicated in logic block 304. A user profile registered with a social media website is consulted and user preferences are displayed as indicated, in logic block 308. A determination is made as to whether or not the content passed the threshold value for display in decision block 312. If the content did not exceed the threshold value for display the score for the skipped content was below the threshold value), the content can be displayed without any skipped content as indicated in logic block 320. If the score was equal to or higher than the threshold valve, the content is skipped or the user is prompted depending on user preferences as indicated in logic block 316. With regard to user preferences when registering with a social network, the user profile could be set up to skip content automatically based on the score, or the user's profile could cause a message or other indication to be displayed giving the user the option to skip tagged content. In one embodiment, the user can press any key on a keypad associated with the client device to display content that would otherwise be skipped automatically.

### Scoring of Offensive Content

In the following simplified example, the content could be classified by the system as potentially offensive depending on the computed score. The system could be configurable to define the weights of the various categories when deciding when content was skipped because it was offensive, or for some other reason.

TABLE 1

| Category | Score | Weight | Effective score |
|---|---|---|---|
| Violence | 7 | 2.0 | 14.0 |
| Sexuality | 4 | 2.5 | 10.0 |
| Language | 9 | 2.0 | 18.0 |
| Total score | 20 | | 42.0 |

### Additional Factors

The system could use additional factors such as viewing time or viewing location (e.g., which of two or more televisions in a given residence or other building) that could act as multipliers affecting the overall score. For example, if the viewing time is 4:00 pm the system could inflate or deflate the score as needed if it suspects children might be present. Similarly, if the viewing location is in the family room (versus another room), the skipped content score could be inflated (e.g., b a factor of 1.5) to reflect that the content was likely skipped because it was offensive to younger viewers (e.g., due to language, or violence, etc.). The actual multiplier used could be customized based on user preferences.

### Social Network Data

The system could collect and use data from social networks which could be factored into the scoring process. For example, social network profiles can be queried to determine if a given household has young children and the system could be configured to vary the score based on that determination. To take another example, if the social network data indicates the children are at school (or at a friend's house, etc.) at a given time, the system could use a different weight (again based on user preference) when it detects skipped content. If the system is relatively sure that only adults are home, the system might be less certain that the skipped content was skipped because it was offensive versus being skipped for some other reason. The system could be configurable to respect the possibility that in some households age would not be as significant factor (e.g., if what is offensive to children is also offensive to adults) depending on personal viewing preferences, etc.

Existing technology could be used to examine images, subtitles, and sound to detect automatically violence, sexual content, and inappropriate language, etc. The system can be configured to tag content automatically as inappropriate (e.g., for certain ages) depending on the individual category scores or depending on the total score and overall threshold. In some embodiments, if a predefined threshold is exceeded for a particular category, such as violence, then the content could be tagged automatically as inappropriate regardless of overall score and threshold.

### Sharing of Metadata Across Social Networks and Television Services

In one embodiment, a digital content streaming service, such as Netflix™, could share this tagged content with other users and enable other users to skip those small sections given the likelihood that the sections are inappropriate for their children as well. The tagged streaming content could be shared without charge as a product enhancement, or could be offered as a fee-based service.

In one embodiment, skipped content could be represented in the main content bar which is typically displayed as a slider of the whole stream at the bottom of a screen display in which the skipped sections can be represented by color segments on the slider bar.

In another embodiment, skipped content could be categorized based on age, i.e., some sections are acceptable for 10 year old children, but not for 7 year old children.

In another embodiment, skipped content could be categorized based on “families” or other predefined groups with similar backgrounds and/or viewing preferences. In this embodiment, members of a given family (or group) can configure scoring thresholds to match their familial and/or individual viewing preferences, resulting in a customized playback experience. Social networks can suggest to users a likely first place (e.g., based on family data and viewing preferences of similar families) which can then be modified based on family specific information, such as religion.

An advantage provided by the disclosed embodiments is the ability to use this type of information and content on a device or web page that will draw viewers and potentially could generate advertising revenue. Similar to metacritic reviews for movies and games, this information could provide real data to publishes, television networks, and content streamers for use.

As will be appreciated by one skilled in the art, the disclosed embodiments may be implemented as a system, method or computer program product. According, disclosed embodiments may take the form of an entirely hardware embodiment, an entirely software embodiment (including firmware, resident software, micro-code, etc.) or a embodiment combining software and hardware aspects that may all generally be referred to herein as a “circuit,” “module” or “system.” Furthermore, the disclosed embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or an suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for the disclosed embodiments may be written in any combination of one or more programming languages, including an object oriented programming language such as Java, Smalltalk, C++ or the like and conventional procedural programming, languages, such as the “C” programming language or similar programming languages. The program code may execute entirely on the user's computer, partly on the user's computer, as a stand-alone software package, partly on the user's computer and partly on a remote computer or entirely on the remote computer or a server. In the latter scenario, the remote computer may be connected to the user's computer through any type of network, including a local area network (LAN) or a wide area network (WAN), or the connection may be made to an external computer for example, through the Internet using an Internet Service Provider).

The disclosed embodiments have been described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions ma be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block(s).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block(s).

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block(s).

The flowchart and b lock diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen a best explain the principles of the embodiments, the practical application or technical improvement over technologies found in the marketplace, or to enable others of ordinary skill in the art to understand the embodiments disclosed herein.

What is claimed:

1. A method for bypassing display of a portion of the content of a media, comprising:
accumulating a history of skipped content for the media;
detecting each portion of skipped content during a display of the media;
automatically determining a reason for each portion of media content that is skipped based on a set of predefined criteria and resulting in a measured value for each portion of skipped content;
tagging each portion of skipped content with the associated measured value; and
sharing information associated with the tagged portions of skipped content across a social network for collaborative reuse.

2. The method for bypassing display of claim 1 further comprising:
detecting a previously skipped portion of media content using the shared information associated with the tagged portions of skipped content;
determining a user's profile and display preferences for media;
determining if the previously skipped portion of media content exceeds a predetermined user display threshold; and
responsive to a user-configurable policy for bypassing content, automatically displaying the content of the media on a user device and skipping content exceeding the predetermined display threshold.

3. The method for bypassing a portion of media content of claim 1 wherein the media comprises a streaming media.

4. The method for bypassing a portion of media content of claim 1 wherein the reason for skipping a media section comprises at least one of a user selection and a collaborative exchange.

5. The method for bypassing a portion of media content of claim 4 wherein the collaborative exchange comprises user social networks.

6. The method for bypassing a portion of media content of claim 1 wherein the reason for skipping a media section comprises at least one of boring content, violent content, sexual content, language content, and previously viewed content.

7. The method for bypassing a portion of media content of claim 1 wherein the history of skipped sections are accumulated utilizing user activity and the likelihood of matching criteria utilizing one or more items selected from the group comprising social network information, timing, analysis of the skipped media, analysis of subtitles, and analysis of sound.

8. A system for bypassing display of a portion of the content of a media received from a media server, comprising:
a media content data store for accumulating a history of skipped content for the media;
an application server for storing a plurality of metadata associated with a skipped content in the media content data store;
a user preferences data store for storing a user's profile and display preferences for media;
a web server for exposing a web service interface for tagging of skipped content;
a processor for executing a plurality of modules, including:
a skipped content detection module for detecting each portion of skipped content during a display of the media;
a scoring service module for automatically determining a reason for each portion of media content that is skipped based on a set of predefined criteria and resulting in a measured value for each portion of skipped content;
a tagging service module for tagging each portion of skipped content with the associated measured value; and
a metadata sharing module for sharing information associated with the tagged portions of skipped content across a social network for collaborative reuse.

9. The system for bypassing display of claim 8 wherein:
the skipped content detection module detects a previously skipped portion of media content using the shared information associated with the tagged portions of skipped content;
the scoring service module determines if the previously skipped portion of media content exceeds a predetermined user display threshold; and
the metadata sharing module, responsive to a user-configurable policy for bypassing content, automatically displays the content of the media on a user device and skips content exceeding the predetermined display threshold.

10. The system for bypassing display of claim 8 wherein the media server streams the media to a user over a broadband communications system.

11. The system for bypassing display of claim 8 wherein the reason for skipping a media section comprises at least one of a user selection and a collaborative exchange.

12. The system for bypassing display of claim 8 wherein the reason for skipping a media section comprises at least one of boring content, violent content, sexual content, language content, and previously viewed content.

13. The system for bypassing display of claim 8 wherein the history of skipped sections are accumulated utilizing user activity and the likelihood of matching criteria utilizing one or more items selected from the group comprising social network information, timing, analysis of the skipped media, analysis of subtitles, and analysis of sound.

14. A computer program product for bypassing display of a portion of the content of a media received from a media server when executed on a computer processor, the computer program product comprising a tangible computer readable storage medium having encoded thereon:
program instructions that cause the processor to accumulate a history of skipped content for the media;
program instructions that cause the processor to detect each portion of skipped content during a display of the media;
program instructions that cause the processor to automatically determine a reason for each portion of media content that is skipped based on a set of predefined criteria and resulting in a measured value for each portion of skipped content;
program instructions that cause the processor to tag each portion of skipped content with the associated measured value; and
program instructions that cause the processor to share information associated with the tagged portions of skipped content across a social network for collaborative reuse.

15. The computer program product for bypassing display of claim 14 wherein the computer readable storage medium has encoded thereon:
program instructions that cause the processor to detect a previously skipped portion of media content using the shared information associated with the tagged portions of skipped content;
program instructions that cause the processor to determine a user's profile and display preferences for media;
program instructions that cause the processor to determine if the previously skipped portion of media content exceeds a predetermined user display threshold; and
program instructions, responsive to a user-configurable policy for bypassing content, that cause the processor to automatically display the content of the media on a user device and skip content exceeding the predetermined display threshold.

16. The computer program product for bypassing display of claim 14 wherein the media comprises a streaming media.

17. The computer program product for bypassing display of claim 14 wherein the reason for skipping a media section comprises at least one of a user selection and a collaborative exchange.

18. The computer program product for bypassing display of claim 14 wherein the collaborative exchange comprises user social networks.

19. The computer program product for bypassing display of claim 14 wherein the reason for skipping a media section comprises at least one of boring content, violent content, sexual content, language content, and previously viewed content.

20. The computer program product for bypassing display of claim 14 wherein the program instructions that cause the processor to accumulate a history of skipped content for the media utilize user activity and the likelihood of matching criteria based on one or more items selected from the group comprising social network information, timing, analysis of the skipped media, analysis of subtitles, and analysis of sound.
